(19) United States
(12) Patent Application Publication
(10) Pub. No.: US 2026/0091758 A1
(43) Pub. Date: Apr. 2, 2026

(54) VEHICLE CONTROLLER, VEHICLE CONTROL METHOD, AND NON-TRANSITORY COMPUTER-READABLE STORAGE MEDIUM

(71) Applicant: HONDA MOTOR CO., LTD., Tokyo (JP)

(72) Inventors: Vikrant NAGPURE, Tokyo (JP); Yueting ZHAO, Tokyo (JP); Yuka ISHIKAWA, Tokyo (JP); Koya SAITO, Tokyo (JP); Masaumi TANIGUCHI, Tokyo (JP); Yuma SASAKI, Tokyo (JP)

(21) Appl. No.: 19/335,516

(22) Filed: Sep. 22, 2025

(30) Foreign Application Priority Data
Oct. 1, 2024 (JP) 2024-171925

(51) Int. Cl. B60R 25/01; B60R 25/30; B60R 25/31; G06V 20/58; G06V 20/59; G06V 40/18; G06V 40/20

(52) U.S. Cl. CPC B60R 25/01; B60R 25/305; B60R 25/31; G06V 20/58; G06V 20/593; G06V 40/18; G06V 40/20

(57) ABSTRACT

A vehicle controller 1 includes a vehicle interior image acquirer 31 that acquires a vehicle interior image, a motion recognizer 36 that recognizes a current motion of an occupant based on the vehicle interior image, a motion predictor 37 that predicts a prospective motion of the occupant based on the current motion, and a device controller 33 that controls a device 3 (4, 5) installed in the vehicle. The device controller 33 executes a first control of the device 3 (4, 5) based on the prospective motion when a first condition is satisfied, execute a second control of the device when a second condition is satisfied, and execute a suspension control that suspends control of the device 3 (4, 5) when the second condition is unsatisfied.

### TECHNICAL FIELD

The present invention relates to a vehicle controller, a vehicle control method, and a non-transitory computer-readable storage medium.

### BACKGROUND ART

In recent years, research and development has been conducted to acquire data on the motion of a user and to provide assistance based thereon. For example, JP7410796B discloses a vehicle controller that controls door opening based on an image of a person outside a vehicle captured by an external camera and an image of an occupant inside the vehicle captured by an in-vehicle camera. The vehicle controller opens the door when a person outside the vehicle is identified as a specific person and the occupant performs a specific motion.

In such a vehicle controller, it is required that the control of a device be adapted to the intention of the occupant. For example, even when the occupant performs a specific motion, the occupant may wish to cancel the operation of the device thereafter.

### SUMMARY OF THE INVENTION

In view of the above background, an object of the present invention is to provide a vehicle controller, a vehicle control method, and a storage medium that enable control of a device according to the intention of an occupant. Accordingly, one aspect of the present invention aims to contribute to the development of sustainable transportation systems.

To achieve such an object, one aspect of the present invention provides a vehicle controller including: a vehicle interior image acquirer configured to acquire a vehicle interior image, which is an image of an interior of a vehicle cabin of a vehicle; a motion recognizer configured to recognize a current motion of an occupant based on the vehicle interior image; a motion predictor configured to predict a prospective motion of the occupant based on the current motion; and a device controller configured to control a device installed in the vehicle. The device controller is configured to: execute a first control of the device based on the prospective motion when a first condition is satisfied, the first condition being a condition that the prospective motion predicted at a first time point corresponds to a predetermined specific motion; execute a second control of the device when a second condition is satisfied, the second condition being a condition that the current motion recognized based on the vehicle interior image at a second time point, which comes after a prescribed time elapses from the first time point, corresponds to the specific motion; and execute a suspension control that suspends control of the device when the second condition is unsatisfied.

Another aspect of the present invention provides a vehicle control method including: acquiring, by a computer, a vehicle interior image, which is an image of an interior of a vehicle cabin of a vehicle; recognizing, by the computer, a current motion of an occupant based on the vehicle interior image; predicting, by the computer, a prospective motion of the occupant based on the vehicle interior image; executing, by the computer, a first control of a device of the vehicle based on the prospective motion when a first condition is satisfied, the first condition being a condition that the prospective motion predicted at a first time point corresponds to a predetermined specific motion; executing, by the computer, a second control of the device when a second condition is satisfied, the second condition being a condition that the current motion recognized based on the vehicle interior image at a second time point, which comes after a prescribed time elapses from the first time point, corresponds to the specific motion; and executing, by the computer, a suspension control that suspends control of the device when the second condition is unsatisfied.

Another aspect of the present invention provides a non-transitory computer-readable storage medium comprising a control program, wherein the control program, when executed by a computer, executes a vehicle control method, including: acquiring, by a computer, a vehicle interior image, which is an image of an interior of a vehicle cabin of a vehicle; recognizing, by the computer, a current motion of an occupant based on the vehicle interior image; predicting, by the computer, a prospective motion of the occupant based on the vehicle interior image; executing, by the computer, a first control of a device of the vehicle based on the prospective motion when a first condition is satisfied, the first condition being a condition that the prospective motion predicted at a first time point corresponds to a predetermined specific motion; executing, by the computer, a second control of the device when a second condition is satisfied, the second condition being a condition that the current motion recognized based on the vehicle interior image at a second time point, which comes after a prescribed time elapses from the first time point, corresponds to the specific motion; and executing, by the computer, a suspension control that suspends control of the device when the second condition is unsatisfied.

Thus, according to the above aspects, it is possible to provide a vehicle controller, a vehicle control method, and a storage medium that enable control of the device according to the intentions of an occupant.

### BRIEF DESCRIPTION OF THE DRAWING(S)

FIG. 1 is a block diagram of a vehicle provided with a vehicle controller according to an embodiment;

FIG. 2 is a block diagram of the vehicle controller according to the embodiment;

FIG. 3 is an explanatory diagram showing an example of skeletal information;

FIG. 4 is a flowchart showing an operation of the vehicle controller according to the embodiment;

FIG. 5 is a time chart showing the operation of the vehicle controller according to the embodiment; and

FIG. 6 is a time chart showing the operation of the vehicle controller according to the embodiment.

### DETAILED DESCRIPTION OF THE INVENTION

In the following, embodiments of a vehicle controller 1, a vehicle control method, and a non-transitory computer-readable storage medium will be described with reference to the drawings.

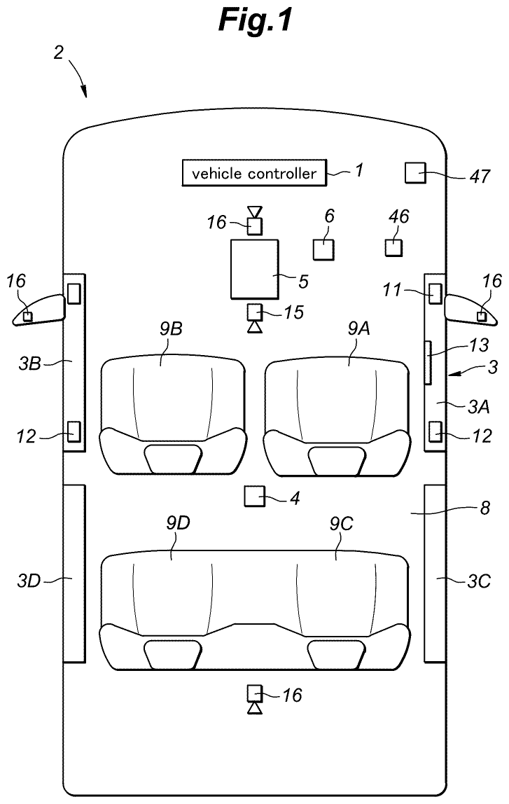

As shown in FIG. 1, the vehicle controller 1 is installed in a vehicle 2. The vehicle 2 may be, for example, a four-wheeled automobile. A plurality of devices controlled by the vehicle controller 1 is installed in the vehicle 2. The device includes a door 3, a lighting device 4, a display device 5, a speaker 6, and the like.

The door 3 functions as an opening and closing member that opens and closes the entrance of the vehicle 2. The door 3 includes a front right door 3A, a front left door 3B, a rear right door 3C, and a rear left door 3D. A vehicle cabin 8 of the vehicle 2 is provided with a front right seat 9A, a front left seat 9B, a rear right seat 9C, and a rear left seat 9D corresponding to the front right door 3A, the front left door 3B, the rear right door 3C, and the rear left door 3D, respectively.

Each door 3 is preferably a hinged door or a sliding door. Each door 3 includes an opening and closing mechanism 11 for opening and closing the door 3, and a locking mechanism 12 for locking and unlocking the door 3. The opening and closing mechanism 11 and the locking mechanism 12 each have an electric motor controlled by the vehicle controller 1. The vehicle controller 1 controls the opening, closing, locking, and unlocking operations of each door 3. Further, a door contact sensor 13 that detects contact by the occupant is provided on the interior side surface of the door 3. The door contact sensor 13 is preferably a capacitance sensor, a pressure sensor, or a membrane switch. The door contact sensor 13 is preferably provided, for example, on a door handle on the interior side surface of the door 3.

The lighting device 4 is preferably installed, for example, on at least one of a roof, an instrument panel, and each door 3 of the vehicle cabin 8. The vehicle controller 1 controls at least one of turning on/off and adjusting the brightness of the lighting device 4.

The display device 5 is preferably installed, for example, on the instrument panel. The display device 5 is preferably, for example, a liquid crystal display. The display device 5 may be a touch panel display that allows touch operation. The vehicle controller 1 controls at least one of on/off of the display device 5 and an image to be displayed on the display device 5. The speaker 6 is controlled by the vehicle controller 1 and makes notifications to the occupant by sound.

The vehicle 2 includes an in-vehicle camera 15 that captures the interior of the vehicle cabin 8 and an external camera 16 that captures the surrounding environment outside the vehicle. The in-vehicle camera 15 and the external camera 16 may be, for example, a digital camera that uses a solid-state image sensor such as a CCD or CMOS. It is preferable that at least one in-vehicle camera 15 is provided. The in-vehicle camera 15 may include, for example, a front seat camera that captures the front portion of the vehicle cabin 8 and a rear seat camera that captures the rear portion of the vehicle cabin 8. The in-vehicle camera 15 is preferably installed on the lower surface of the roof or on the rear-view mirror.

It is preferable that at least one external camera 16 is provided. The external camera 16 may include, for example, a front camera that captures the front of the vehicle 2, a right side camera that captures the right side of the vehicle 2, a left side camera that captures the left side of the vehicle 2, and a rear camera that captures the rear of the vehicle 2. The external camera 16 is preferably installed on the upper portion of the inner surface of a windshield, on the upper portion of the inner surface of a rear window, or on a side mirror of the vehicle 2.

The in-vehicle camera 15 acquires a vehicle interior image, which is an image of the interior of the vehicle cabin 8. The external camera 16 acquires an image of the exterior of the vehicle 2. The vehicle interior image and a vehicle exterior image may be still images that are repeatedly acquired at the prescribed time intervals, or may be video images.

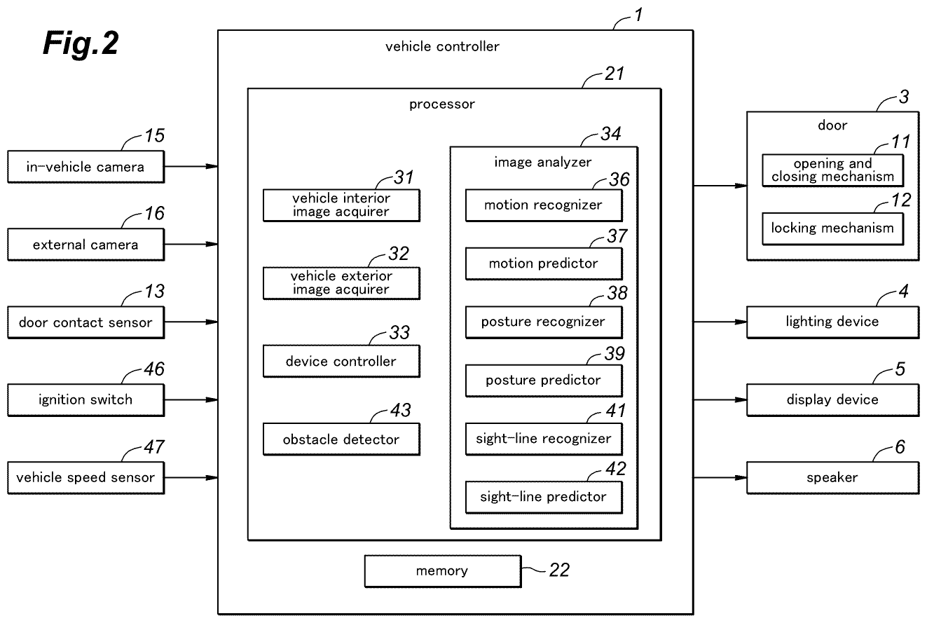

As shown in FIG. 2, the vehicle controller 1 is a computer including a processor 21 and the memory 22 communicatively connected to the processor 21. The processor 21 may include at least one of the following cores: a central processing unit (CPU), a graphics processing unit (GPU), and a reduced instruction set computer (RISC). The memory 22 stores the control program executed by the processor 21 and various data. The memory 22 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle controller 1 may be realized by hardware such as a large scale integration (LSI), an application specific integrated circuit (ASIC), or a field-programmable gate array (FPGA), or may be realized by a combination of software and hardware. The vehicle controller 1 may be composed of a single piece of hardware, or may be composed of plural pieces of hardware capable of communicating with each other. A portion of the vehicle controller 1 may be composed of an external server provided outside the vehicle 2.

The processor 21 realizes various applications by executing the control program stored in the memory 22. The control program may be stored in a removable recordable medium such as a DVD or a CD-ROM, and installed in the memory 22 as the recordable medium is read by a reading device. The control program may also be downloaded and installed in the memory 22 via a communication network such as the Internet.

By executing the control program stored in the memory 22, the processor 21 functions as a vehicle interior image acquirer 31, a vehicle exterior image acquirer 32, a device controller 33, and an image analyzer 34. The image analyzer 34 includes a motion recognizer 36, a motion predictor 37, a posture recognizer 38, a posture predictor 39, a sight-line recognizer 41, a sight-line predictor 42, and an obstacle detector 43. The processor 21 executes the control program, and the vehicle controller 1, which is a computer, executes the vehicle control method. The memory 22 functions as a non-transitory computer-readable storage medium comprising the control program. The control program, when executed by the processor 21 of the vehicle controller 1, executes the vehicle control method.

The vehicle controller 1 is connected to the in-vehicle camera 15, the external camera 16, the door 3, the lighting device 4, the display device 5, and the speaker 6. Further, it is preferable that an ignition switch 46 for turning on and off a drive source such as an internal combustion engine or an electric motor, and a vehicle speed sensor 47 for detecting the speed of the vehicle 2 are connected to the vehicle controller 1. The in-vehicle camera 15 transmits the acquired vehicle interior image to the vehicle controller 1. The external camera 16 transmits the captured vehicle exterior image to the vehicle controller 1. The vehicle controller 1 controls the door 3, the lighting device 4, and the display device 5.

The vehicle interior image acquirer 31 controls the in-vehicle camera 15 to acquire the vehicle interior image, which is an image of the interior of the vehicle cabin 8 of the vehicle 2. The vehicle exterior image acquirer 32 controls the external camera 16 to acquire the vehicle exterior image, which is an image of the exterior of the vehicle 2.

The image analyzer 34 analyzes the vehicle interior image acquired by the vehicle interior image acquirer 31. Further, the image analyzer 34 analyzes the vehicle exterior image acquired by the vehicle exterior image acquirer 32.

The motion recognizer 36 recognizes the current motion of the occupant based on the vehicle interior image. The current motion refers to the motion of the occupant in the vehicle interior image, i.e., the motion of the occupant when the vehicle interior image is acquired. The motion includes, for example, operating the display device 5, operating the ignition switch 46, operating the handbrake switch, operating the shift switch, adjusting the seat position, fastening or unfastening the seat belt, lifting luggage, gripping the door handle, and exiting the vehicle.

The motion recognizer 36 may, for example, use the machine learning model to recognize the current motion of the occupant based on the vehicle interior image. The machine learning model is trained to output the current motion based on the vehicle interior image as input. The machine learning model may be constructed by inputting a dataset including a plurality of vehicle interior images and the current motion corresponding to the plurality of vehicle interior images into a neural network and performing machine learning. The output of the motion recognizer 36 may be text representing each current motion or an identification number assigned to each current motion. The vehicle interior image input to the machine learning model may be a single frame of the vehicle interior image at a certain time point, i.e., a still image, or may be a plurality of consecutive frames of the vehicle interior image from a certain time point, i.e., a video image.

Further, the motion recognizer 36 detects the position of the occupant. The position of the occupant may be represented by coordinates, or may be represented relative to the seat, such as “the front right seat 9A.”

In a case where a plurality of occupants is present in the vehicle interior image, the motion recognizer 36 may recognize the current motion and position for each of the plurality of occupants.

The motion predictor 37 predicts the prospective motion of the occupant based on the current motion. The prospective motion refers to the motion predicted to be performed by the occupant after a prescribed period, for example, 0.5 to 2 seconds, has elapsed from the time point at which the vehicle interior image is acquired. For example, in a case where the current motion is the motion of the occupant lifting luggage, the motion of the occupant exiting the vehicle 2 is set as the prospective motion corresponding to the current motion. The exiting motion of the occupant includes the motion of the occupant unlocking the locking mechanism 12 of the door 3, the motion of the occupant gripping the door handle, the motion of the occupant pushing the door 3, and the like.

The motion predictor 37 may, for example, use the machine learning model to predict the prospective motion of the occupant based on the current motion. The machine learning model is trained to output the prospective motion based on the current motion as input. The machine learning model may be constructed by inputting a dataset including a plurality of current motions and the prospective motions corresponding to the plurality of current motions into a neural network and performing machine learning. The output of the motion predictor 37 may be text representing each prospective motion or an identification number assigned to each current motion. The input of the motion predictor 37 may be text representing each current motion or an identification number assigned to each current motion. The current motion output from the motion recognizer 36 is used as an input to the motion predictor 37.

It is preferable that the training dataset for constructing the motion predictor 37 is created based on time-continuous vehicle interior images. The motion of the occupant at a certain time point in the vehicle interior image is stored as the current motion, and the motion of the occupant after the elapse of the prescribed period from that time point is stored as the prospective motion. A dataset may be created by collecting a plurality of mutually corresponding current motions and prospective motions.

Further, the motion predictor 37 detects the position of the occupant in the same manner as the motion recognizer 36. In a case where a plurality of occupants exists in the vehicle interior image, the motion predictor 37 may recognize the prospective motion and position for each of the plurality of occupants.

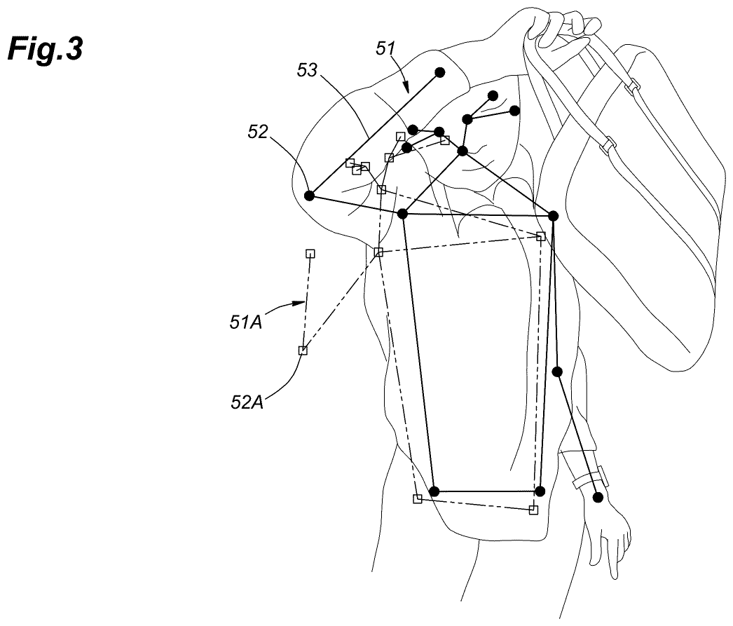

The posture recognizer 38 recognizes the current posture of the occupant based on the vehicle interior image. The current posture refers to the posture of the occupant in the vehicle interior image, i.e., the posture of the occupant when the vehicle interior image is acquired. The posture includes information about the positions of the respective parts of the body of the occupant. As shown in FIG. 3, according to the present embodiment, the posture recognizer 38 acquires skeletal information 51 of the occupant in the vehicle interior image based on the vehicle interior image, and recognizes the acquired skeletal information 51 as the current posture of the occupant. The skeletal information 51 includes the positions of a plurality of representative points 52 suitable for representing the shape of the occupant, and the links 53 that connect the representative points 52 to each other. The plurality of representative points 52 may include the positions such as left and right shoulder joints, left and right hip joints, left and right elbow joints, left and right wrists, nose, left and right eyes, left and right eyebrows, and the like.

The posture recognizer 38 may, for example, use the machine learning model to acquire the skeletal information 51 including the positions of a plurality of representative points 52 of the occupant based on the vehicle interior image. The machine learning model is trained to output a plurality of representative points 52 of the occupant and the positions thereof, i.e., the skeletal information 51, based on the vehicle interior image as input. The machine learning model may be constructed by inputting a dataset including a plurality of vehicle interior images and a plurality of representative points 52 of the occupant corresponding to the plurality of vehicle interior images into a neural network and performing machine learning.

The posture predictor 39 predicts the prospective motion of the occupant based on the current posture of the occupant. The prospective posture refers to the predicted posture of the occupant after the prescribed period, for example, 0.5 to 2 seconds, has elapsed from the time point at which the vehicle interior image is acquired. For example, in a case where the current posture is the posture of the occupant lifting luggage, the posture in which the occupant is about to exit the vehicle 2 is set as the prospective posture corresponding to the current posture. The posture of the occupant about to exit the vehicle 2 may be, for example, a posture in which the upper body of the occupant faces the door 3, a posture in which the head of the occupant faces the door 3, or a posture in which the arm of the occupant is extended toward the door 3.

The posture predictor 39 may, for example, use the machine learning model to predict the prospective posture of the occupant based on the current posture. The machine learning model is trained to output the prospective posture based on the current posture as input. The machine learning model may be constructed by inputting a dataset including a plurality of current postures and the prospective postures corresponding to the plurality of current postures into a neural network and performing machine learning. The output of the posture predictor 39 includes a prospective skeletal information 51A of the occupant, i.e., the prospective positions of a plurality of representative points 52A of the occupant.

It is preferable that the training dataset for constructing the posture predictor 39 is created based on time-continuous vehicle interior images. The posture of the occupant at a certain time point in the vehicle interior image is stored as the current posture, and the posture of the occupant after the elapse of the prescribed period from that time point is stored as the prospective posture. A dataset may be created by collecting a plurality of mutually corresponding current postures and prospective postures.

The sight-line recognizer 41 recognizes the current sight-line of the occupant based on the vehicle interior image. The current sight-line refers to the sight-line of the occupant in the vehicle interior image, i.e., the sight-line of the occupant when the vehicle interior image is acquired. The sight-line may be represented by a starting point of the sight-line and a sight-line vector that represents the direction of the sight-line. The starting point of the sight-line may be, for example, the point between the eyes of the occupant.

The sight-line recognizer 41 may, for example, use the machine learning model to acquire the sight-line of the occupant based on the vehicle interior image. The machine learning model is trained to output the sight-line of the occupant based on the vehicle interior image as input. The machine learning model may be constructed by inputting a dataset including a plurality of vehicle interior images and sight-line of the occupant corresponding to the plurality of vehicle interior images into a neural network and performing machine learning.

The sight-line predictor 42 predicts the prospective sight-line of the occupant based on the vehicle interior image. The prospective sight-line refers to the projected sight-line of the occupant after a prescribed period, for example, 0.5 to 2 seconds, has elapsed from the time point at which the vehicle interior image is acquired. For example, in a case where the current sight-line corresponds to the sight-line of the occupant lifting luggage, the sight-line in which the occupant is about to exit the vehicle 2 is set as the prospective posture corresponding to the current posture. The sight-line of the occupant about to exit the vehicle 2 may be a sight-line directed toward the door 3.

The sight-line predictor 42 may, for example, use the machine learning model to predict the prospective sight-line of the occupant based on the current sight-line. The machine learning model is trained to output the prospective sight-line based on the current sight-line as input. The machine learning model may be constructed by inputting a dataset including a plurality of current sight-lines and the prospective sight-line corresponding to the plurality of current sight-lines into a neural network and performing machine learning.

It is preferable that the training dataset for constructing the sight-line predictor 42 is created based on time-continuous vehicle interior images. The sight-line of the occupant at a certain time point in the vehicle interior image is stored as the current sight-line, and the sight-line of the occupant after the elapse of the prescribed period from that time point is stored as the prospective sight-line. A dataset may be created by collecting a plurality of mutually corresponding current sight-lines and prospective sight-lines.

The device controller 33 controls the device installed in the vehicle 2. The device controlled by the device controller 33 may be the door 3, the lighting device 4, the display device 5, or the like. The device controller 33 controls the device based on at least the current motion recognized by the motion recognizer 36 and the prospective motion predicted by the motion predictor 37. Further, the device controller 33 may control the device based on the current motion recognized by the motion recognizer 36, the prospective motion predicted by the motion predictor 37, the current posture recognized by the posture recognizer 38, and the prospective posture predicted by the posture predictor 39. Further, the device controller 33 may control the device based on the current motion recognized by the motion recognizer 36, the prospective motion predicted by the motion predictor 37, the current sight-line recognized by the sight-line recognizer 41, and the prospective sight-line predicted by the sight-line predictor 42. Further, the device controller 33 may control the device based on the current motion recognized by the motion recognizer 36, the prospective motion predicted by the motion predictor 37, the current posture recognized by the posture recognizer 38, the prospective posture predicted by the posture predictor 39, the current sight-line recognized by the sight-line recognizer 41, and the prospective sight-line predicted by the sight-line predictor 42.

The control of the device executed by the device controller 33 includes unlocking control, locking control, opening control, and closing control of the door 3, turning on control and turning off control of the lighting device 4, and on/off control of the display device 5. The device controller 33 controls the locking mechanism 12 of the door 3 in the unlocking control and the locking control of the door 3. The device controller 33 controls the locking mechanism 12 and the opening and closing mechanism 11 of the door 3 in the opening control and the closing control of the door 3.

The device controller 33 identifies the door 3 to be controlled based on the position of the occupant acquired from the vehicle interior image. For example, when the device controller 33 determines that the occupant is present at the front right seat 9A, the device controller 33 controls the front right door 3A corresponding to the front right seat 9A.

As an example, the device controller 33 executes a first control of the device based on the prospective motion when a first condition is satisfied, the first condition being that the prospective motion predicted at the first time point corresponds to the predetermined specific motion. Then, the device controller 33 executes a second control of the device when the second condition is satisfied, the second condition being that the current motion recognized based on the vehicle interior image at the second time point, which comes after a prescribed time elapses from the first time point, corresponds to the specific motion. On the other hand, the device controller 33 executes a suspension control that suspends control of the device when the second condition is unsatisfied.

The specific motion is set according to the device to be controlled. For example, when the door 3 is the control object, the specific motion is an exit motion from the vehicle. The exit motion includes gripping the door handle of the door 3, pushing the door 3 in the opening direction, turning the upper body toward the door 3, moving the upper body closer to the door 3, and the like. The prospective motion corresponds to the specific motion, meaning that the prospective motion matches at least one of the motions included in the specific motion.

The second time point may be a time point that is 0.5 to 1.0 seconds after the first time point. The prospective motion predicted at the first time point may be predicted as the motion at the second time point.

The first control, the second control, and the suspension control are set according to the device to be controlled. For example, when the door 3 is the control target, the device controller 33 may unlock the door 3 in the first control, open the door 3 in the second control, and lock the door 3 in the suspension control. Further, the device controller 33 may close the door 3 and then lock the door 3 in a case where the suspension control is executed while the door 3 is in an open state.

The obstacle detector 43 detects the obstacle around the vehicle 2 based on the vehicle exterior image. More specifically, the obstacle detector 43 detects the obstacle around each door 3 of the vehicle 2 based on the vehicle exterior images. The obstacle includes, for example, a person, another vehicle 2, a bicycle, a wall, and a guardrail.

With the above configuration, the vehicle controller 1 predicts the prospective motion of the occupant based on the motion of the occupant at the first time point. When the prospective motion of the occupant corresponds to the specific motion, the vehicle controller 1 executes the first control of the device. When the device is the door 3, the specific motion is the exit motion from the vehicle, and the first control is the unlocking control of the door 3. Next, the vehicle controller 1 recognizes the current motion of the occupant at the second time point, and when the current motion at the second time point corresponds to the specific motion, the vehicle controller 1 executes a first control of the device. When the device is the door 3, the second control is the opening control of the door 3. On the other hand, when the current motion at the second time point does not correspond to the specific motion, the vehicle controller 1 executes the suspension control of the device. When the device is the door 3, the suspension control is the locking control of the door 3.

According to the vehicle controller 1, the prospective motion of the occupant can be predicted based on the current motion of the occupant at the first time point, and the device can be controlled according to the prospective motion. That is, the vehicle controller 1 can predict the motion of the occupant and promptly control the device according to the predicted motion of the occupant. Further, the vehicle controller 1 can determine whether the prediction of the prospective motion at the first time point is correct by verifying whether the current motion of the occupant at the second time point corresponds to the specific motion. When the current motion of the occupant at the second time point corresponds to the specific motion, i.e., when the prediction of the prospective motion at the first time point is correct, the vehicle controller 1 continues to control the device and executes the second control. On the other hand, when the current motion of the occupant at the second time point does not correspond to the specific motion, i.e., when the prediction of the prospective motion at the first time point was incorrect, the vehicle controller 1 executes the suspension control to suspend control of the device.

As an example, the device controller 33 executes the first control when the first condition and a third condition are satisfied, the third condition being that the prospective motion predicted at the first time point corresponds to the predetermined specific posture. Then, the device controller 33 executes the second control when the second condition and a fourth condition are satisfied, the fourth condition being that the current posture recognized based on the vehicle interior image at the second time point corresponds to the specific posture. On the other hand, when either the second condition or the fourth condition is unsatisfied, the suspension control is executed.

The specific posture is set according to the device being controlled. For example, when the door 3 is the control object, the specific posture is a posture corresponding to the exit motion from the vehicle. The posture corresponding to the exit motion includes a posture in which the upper body of the occupant faces the door 3, a posture in which the head of the occupant faces the door 3, a posture in which the hand of the occupant is extended toward the door 3, or the like. Whether the prospective posture corresponds to the specific posture may be determined based on, for example, whether the distance between the representative points 52A included in the skeletal diagram of the prospective posture of the occupant and the representative points included in the skeletal diagram of the occupant set as the specific posture is equal to or less than the predetermined determination value.

According to the vehicle controller 1, a prospective action of the occupant is predicted based on the prospective posture in addition to the prospective motion of the occupant, thereby improving the accuracy of the prediction.

As an example, the device controller 33 executes the first control when the first condition and a fifth condition are satisfied, the fifth condition being that the prospective sight-line predicted at the first time point is directed toward the predetermined specific area. Then, the device controller 33 executes the second control when the second condition and a sixth condition are satisfied, the sixth condition being that the current sight-line recognized based on the vehicle interior image at the second time point is directed toward the specific area. On the other hand, when either the second condition or the sixth condition is unsatisfied, the suspension control is executed.

The specific area is set according to the device to be controlled. For example, when the door 3 is the control object, the specific area may be the area including the door 3. When the lighting device 4 is the control object, the specific area is the area including the lighting device 4. When the display device 5 is the control object, the specific area is the area including the display device 5. Whether the prospective sight-line or the current sight-line is directed toward the specific area may be determined based on whether the prospective sight-line or the current sight-line passes through the specific area.

According to the vehicle controller 1, the prospective action of the occupant is predicted based on the prospective sight-line in addition to the prospective motion of the occupant, thereby improving the accuracy of the prediction.

As an example, the device controller 33 may execute the first control when the first condition, the third condition, and the fifth condition are satisfied. The device controller 33 may execute the second control when the second condition, the fourth condition, and the sixth condition are satisfied. On the other hand, when any one of the second condition, the fourth condition, or the sixth condition is unsatisfied, the device controller 33 may execute the suspension control.

According to the vehicle controller 1, the prospective action of the occupant is predicted based on the prospective motion, the prospective posture, and the prospective sight-line, thereby improving the accuracy of the prediction.

The device controller 33 may execute the suspension control when the obstacle detector 43 detects the obstacle at the second time point. This prevents the door 3 from colliding with the obstacle.

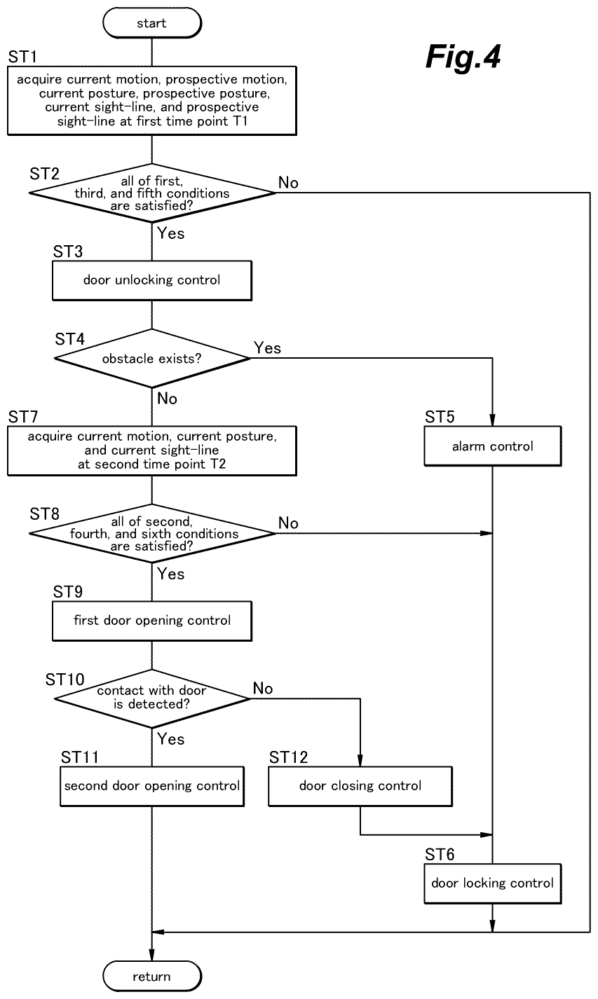

With reference to the flowchart in FIG. 4, an example of the device control procedure executed by the vehicle controller 1 will be described. In controlling the device, the vehicle controller 1 predicts that the occupant is exiting the vehicle and opens the door 3. The vehicle controller 1 starts the device control when the predetermined start condition is satisfied. The start condition may be, for example, that the vehicle speed is equal to or less than the predetermined stop determination value, or that the ignition switch 46 is turned off. The vehicle controller 1 may acquire the vehicle speed from the vehicle speed sensor 47 installed in the vehicle 2. The vehicle controller 1 repeatedly executes the device control at prescribed time intervals.

First, the vehicle controller 1 acquires the current motion, the prospective motion, the current posture, the prospective posture, the current sight-line, and the prospective sight-line at the first time point T1 (ST1). The vehicle controller 1 acquires the current motion, the current posture, and the current sight-line of the occupant based on the vehicle interior image acquired at the first time point T1. Further, the vehicle controller 1 acquires the prospective motion based on the current motion acquired at the first time point T1, acquires the prospective posture based on the current posture acquired at the first time point T1, and acquires the prospective sight-line based on the current sight-line acquired at the first time point T1. The prospective motion, the prospective posture, and the prospective sight-line acquired here are predicted motions, postures, and sight-lines of the occupant at the second time point T2.

Next, the vehicle controller 1 determines whether the first condition, the third condition, and the fifth condition are satisfied (ST2). In this control, so as to predict the exit of the occupant from the vehicle, the exit motion of the occupant, the posture corresponding to the exit motion, and the sight-line corresponding to the exit motion are set as the specific motion, the specific posture, and the specific sight-line, respectively.

When the first condition, the third condition, and the fifth condition are satisfied (ST2: Yes), the vehicle controller 1 executes the unlocking control to unlock the door 3 (ST3). At this time, the vehicle controller 1 identifies the door 3 to be controlled based on the position of the occupant acquired from the vehicle interior image. When any one of the first condition, the third condition, and the fifth condition is unsatisfied (ST1: No), the process returns to step ST1 via return.

After the process in step ST3, the vehicle controller 1 determines whether an obstacle exists outside the door 3 (ST4). The process in step ST4 may be performed at the second time point T2, which comes after the prescribed time elapses from the first time point T1. The vehicle controller 1 determines whether the obstacle exists outside the door 3 corresponding to the position of the occupant, based on the vehicle exterior image acquired at the second time point T2.

When the obstacle exists outside the door 3 (ST4: Yes), the vehicle controller 1 executes alarm control to inform the occupant of the presence of an obstacle outside the vehicle (ST5). In the alarm control, the vehicle controller 1 controls at least one of the display device 5 and the speaker 6 to issue an alarm.

After the process in step ST5, the vehicle controller 1 executes the locking control of the door 3 (ST6). In the locking control of the door, the vehicle controller 1 locks the door 3 that is unlocked in step ST3. After the process in step ST6, the process returns to step ST1 via return.

When no obstacle exists outside the door 3 (ST4: No), the vehicle controller 1 acquires the current motion, the current posture, and the current sight-line at the second time point T2 (ST7). The vehicle controller 1 acquires the current motion, the current posture, and the current sight-line of the occupant based on the vehicle interior image acquired at the second time point T2.

Next, the vehicle controller 1 determines whether the second condition, the fourth condition, and the sixth condition are satisfied (ST8).

When the second condition, the fourth condition, and the sixth condition are satisfied (ST8: Yes), the vehicle controller 1 executes a first door opening control (ST9). In the first door opening control, the vehicle controller 1 opens the door 3 corresponding to the position of the occupant by a predetermined degree. In the first door opening control, the vehicle controller 1 sets the opening degree of the door 3 to, for example, 5 to 20%. At this time, the vehicle controller 1 controls the locking mechanism 12 of the door 3 to enable the door 3 to be opened, and also controls the opening and closing mechanism 11 of the door 3 to open the door 3.

When any one of the second condition, the fourth condition, or the sixth condition is unsatisfied (ST8: No), the vehicle controller 1 executes the locking control of the door (ST6).

After the process in step ST9, the vehicle controller 1 detects whether the occupant comes into contact with the door 3 (ST10). The vehicle controller 1 may determine whether the occupant comes into contact with the corresponding door 3 based on a signal from the door contact sensor 13. The purpose of the determination in step ST10 is to detect the exit motion of the occupant.

When the occupant comes into contact with the door 3 (ST10: Yes), the vehicle controller 1 executes a second door opening control (ST11). In the second door opening control, the vehicle controller 1 opens the door 3 corresponding to the position of the occupant by a predetermined degree. In the second opening control, the vehicle controller 1 sets the opening degree of the door 3 to, for example, 20 to 100%. In other words, the opening degree of the door 3 after the second door opening control is greater than the opening degree of the door 3 after the first door opening control. The opening degree of the door 3 after the second door opening control may be set to an opening degree that allows the occupant to exit the vehicle. The vehicle controller 1 controls the opening and closing mechanism 11 of the door 3 to open the door 3.

When the occupant does not contact the door 3 (ST10: No), the vehicle controller 1 executes the closing control of the door 3 (ST12). In the closing control of the door 3, the vehicle controller 1 closes the door 3 corresponding to the position of the occupant. This causes the opening degree of the door 3 to become 0%. The vehicle controller 1 controls the opening and closing mechanism 11 of the door 3 to close the door 3. After the process in step ST12, the vehicle controller 1 executes the process in step ST6.

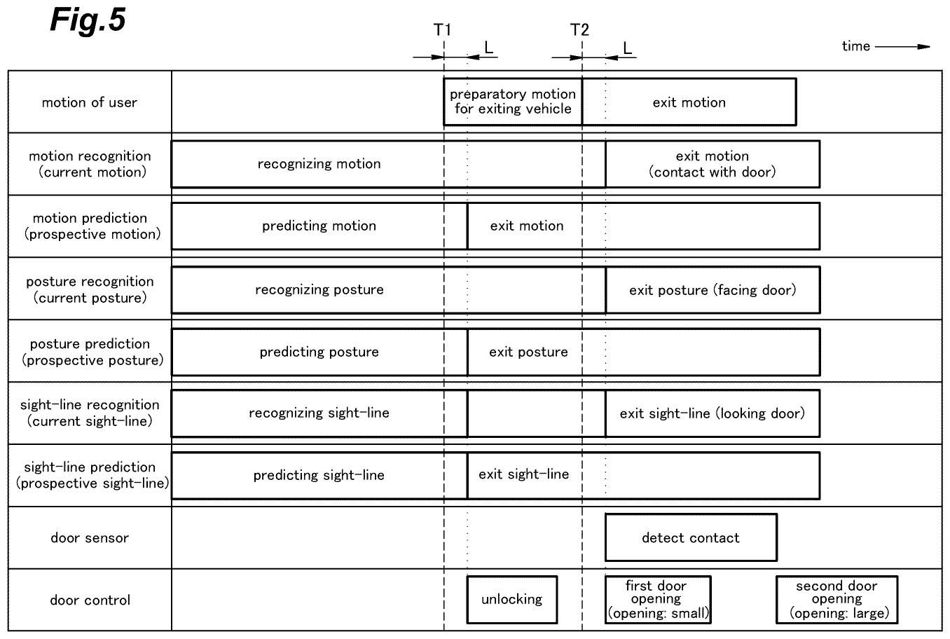

The vehicle controller 1 operates as shown in FIG. 5 by executing the above-mentioned device control. The vehicle controller 1 acquires the current motion, the current posture, and the current sight-line based on the vehicle interior image at the first time point T1, and acquires the prospective motion, the prospective posture, and the prospective sight-line based on the acquired current motion, posture, and sight-line. Then, when the first condition that the prospective motion corresponds to the specific motion, the third condition that the prospective posture corresponds to the specific posture (exit posture), and the fifth condition that the prospective sight-line is directed toward the specific area (exit sight-line) are satisfied, the vehicle controller 1 executes unlocking control of the door 3 corresponding to the position of the occupant. This unlocks the door 3. Next, the vehicle controller 1 recognizes the current motion, the current posture, and the current sight-line of the occupant at the second time point T2. Then, when the second condition that the current motion at the second time point T2 corresponds to the specific motion, the fourth condition that the current posture at the second time point T2 corresponds to the specific posture, and the sixth condition that the current sight-line at the second time point T2 is directed toward the specific area are satisfied, the vehicle controller 1 executes the first door opening control of the door 3. This opens the door 3 slightly. Thereafter, when detecting the contact of the occupant with the door 3, the vehicle controller 1 executes the second door opening control of the door 3. This opens door 3 further, allowing the occupant to exit from the vehicle. In FIG. 5, the recognition and prediction of the operation, posture, and sight-line executed by the vehicle controller 1 are described in a manner that includes a delay L for each time point T1 and T2. It is preferable that the delay L be as close to zero as possible.

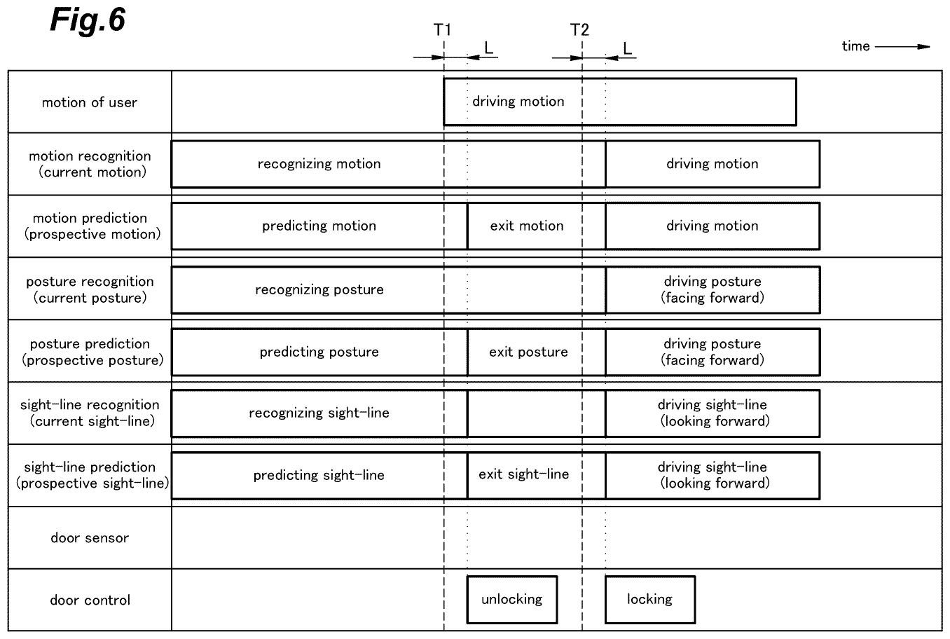

On the other hand, as shown in FIG. 6, when any of the second condition, the fourth condition, or the sixth condition is unsatisfied, the vehicle controller 1 executes the locking control of the door 3. This causes the door 3 to be locked. In this way, even if the vehicle controller 1 incorrectly predicts the prospective motion, the prospective posture, and the prospective sight-line at the first time point T1, it is possible to modify the control of the door 3 to match the intention of the occupant by determining the current motion, the current posture, and the current sight-line of the occupant at the second time point T2.

The embodiment is not limited to the above configuration and can be widely modified.

In the device control procedure shown in FIG. 4, the determination in step ST2 may be replaced with a determination as to whether the first condition is satisfied. The determination in step ST2 may be replaced with a determination as to whether the first condition and the third condition are satisfied. The determination in step ST2 may be replaced with a determination as to whether the first condition and the fifth condition are satisfied. That is, the determination in the step ST2 may be executed based on the prospective motion, or based on both the prospective motion and the prospective posture, or based on both the prospective motion and the prospective sight-line.

The determination in step ST8 may be replaced with a determination as to whether the second condition is satisfied. The determination in step ST8 may be replaced with a determination as to whether the second condition and the fourth condition are satisfied. The determination in step ST8 may be replaced with a determination as to whether the second condition and the sixth condition are satisfied. That is, the determination in step ST8 may be executed based on the current motion, or based on both the current motion and the current posture, or based on both the current motion and the current sight-line.

The vehicle controller 1 may control the lighting device 4 based on the device control procedure. In this case, the device controller 33 may turn on the lighting device 4 in step ST3, keep the lighting device 4 on in step ST9, and turn off the lighting device 4 in step ST6. Moreover, steps ST4, ST5, ST10, ST11, and ST12 may be omitted. Further, in steps ST2 and ST8, the specific motion may be a motion related to the operation of the lighting device 4, the specific posture may be a posture related to the operation of the lighting device 4, and the specific area may be an area including the lighting device 4.

The vehicle controller 1 may control the display device 5 based on the device control procedure. In this case, the device controller 33 may turn on the display of the display device 5 in step ST3, keep the display device 5 on in step ST9, and turn off the display of the display device 5 in step ST6. Moreover, steps ST4, ST5, ST10, ST11, and ST12 may be omitted. Further, in steps ST2 and ST8, the specific motion may be a motion related to the operation of the display device 5, the specific posture may be a posture related to the operation of the display device 5, and the specific area may be an area including the display device 5.

The vehicle controller 1 may execute the opening control and the closing control by using a window panel provided on the upper portion of the door 3 as the opening and closing member.

The motion predictor 37 may predict the prospective motion based on the vehicle interior image. In this case, the motion predictor 37 may, for example, use the machine learning model to predict the prospective motion based on the current image. The machine learning model may be trained to output the prospective motion based on the vehicle interior image as input. The machine learning model may be trained using a dataset including a plurality of vehicle interior images and a plurality of prospective motions respectively corresponding to the plurality of vehicle interior images. Similarly, the posture predictor 39 may predict the prospective posture based on the vehicle interior image. Further, the sight-line predictor 42 may predict the prospective sight-line based on the vehicle interior image.

The motion predictor 37 may predict the prospective motion based on the current motion recognized by the motion recognizer 36 and the prospective posture predicted by the posture predictor 39. In this case, the motion predictor 37 may use the machine learning model to predict the prospective motion based on the current motion and the prospective posture. The machine learning model may be trained to output the prospective motion based on the current motion and the prospective posture as input. The machine learning model may be trained using a dataset including a plurality of current motions and prospective postures, and a plurality of prospective motions respectively corresponding to the plurality of vehicle interior images.

The sight-line recognizer 41 may recognize the direction of the face instead of the sight-line. The sight-line recognizer 41 may also represent, instead of sight-line, a structure toward which the sight-line is directed. For example, the structure may be the door 3, the lighting device 4, the display device 5, the steering wheel, and the windshield.

The motion predictor 37 may predict the prospective motion corresponding to the specific motion based on the operation by the occupant on a device of the vehicle 2 other than the door 3 as the opening and closing member. For example, the device of the vehicle 2 may be the ignition switch 46. The motion predictor 37 may predict the prospective motion based on the signal from the ignition switch 46. For example, when the ignition switch 46 is turned off, the motion predictor 37 may set the exit motion as the prospective motion of the occupant.

The vehicle interior image may be acquired by an imaging radar instead of the in-vehicle camera 15. The imaging radar generates an image of the object, such as shape and size, by mapping based on information acquired by irradiating the object with radio waves and receiving the reflected radio waves. The radio waves are preferably millimeter waves, for example.

As described above, a vehicle controller 1 includes: a vehicle interior image acquirer 31 configured to acquire a vehicle interior image, which is an image of an interior of a vehicle cabin 8 of a vehicle 2; a motion recognizer 36 configured to recognize a current motion of an occupant based on the vehicle interior image; a motion predictor 37 configured to predict a prospective motion of the occupant based on the current motion; and a device controller 33 configured to control a device 3 (4, 5) installed in the vehicle 2. The device controller 33 is configured to: execute a first control of the device 3 (4, 5) based on the prospective motion when a first condition is satisfied, the first condition being a condition that the prospective motion predicted at a first time point corresponds to a predetermined specific motion; execute a second control of the device 3 (4, 5) when a second condition is satisfied, the second condition being a condition that the current motion recognized based on the vehicle interior image at a second time point, which comes after a prescribed time elapses from the first time point, corresponds to the specific motion; and execute a suspension control that suspends control of the device 3 (4, 5) when the second condition is unsatisfied.

According to this aspect, the vehicle controller 1 can promptly control the device 3 (4, 5) based on the prospective motion predicted at the first time point. Further, the vehicle controller 1 determines whether the current motion of the occupant corresponds to the specific motion at the second time point, and continues or suspends control of the device 3 (4, 5) depending on the determination result. Accordingly, it is possible to provide the vehicle controller 1 that enables control of the device 3 (4, 5) according to the intention of the occupant.

Preferably, the vehicle controller 1 further includes: a posture recognizer 38 configured to recognize a current posture of the occupant based on the vehicle interior image; and a posture predictor 39 configured to predict a prospective posture of the occupant based on the current posture. The device controller 33 is configured to: execute the first control when the first condition and a third condition are satisfied, the third condition being a condition that the prospective motion predicted at the first time point corresponds to a predetermined specific posture; execute the second control when the second condition and a fourth condition are satisfied, the fourth condition being a condition that the current posture recognized based on the vehicle interior image at the second time point corresponds to the specific posture; and execute the suspension control when either the second condition or the fourth condition is unsatisfied.

According to this aspect, the prospective action of the occupant is predicted based on the prospective posture in addition to the prospective motion of the occupant, thereby improving the accuracy of the prediction.

Preferably, the motion predictor 37 is configured to predict the prospective motion based on the current motion recognized by the motion recognizer 36 and the prospective posture predicted by the posture predictor 39.

According to this aspect, the accuracy of the prediction of the prospective motion is improved.

Preferably, the vehicle controller 1, further includes: a sight-line recognizer 41 configured to recognize a current sight-line of the occupant based on the vehicle interior image; and a sight-line predictor 42 configured to predict a prospective sight-line of the occupant based on the current sight-line. The device controller 33 is configured to: execute the first control when the first condition and a fifth condition are satisfied, the fifth condition being a condition that the prospective sight-line predicted at the first time point is directed toward a predetermined specific area; execute the second control when the second condition and a sixth condition are satisfied, the sixth condition being a condition that the current sight-line recognized based on the vehicle interior image at the second time point is directed toward the specific area; and execute the suspension control when either the second condition or the sixth condition is unsatisfied.

According to this aspect, the prospective action of the occupant is predicted based on the prospective sight-line in addition to the prospective motion of the occupant, thereby improving the accuracy of the prediction.

Preferably, the vehicle controller 1, further includes: a sight-line recognizer 41 configured to recognize a current sight-line of the occupant based on the vehicle interior image; and a sight-line predictor 42 configured to predict a prospective sight-line of the occupant based on the vehicle interior image. The device controller 33 is configured to: execute the first control when the first condition, the third condition, and a fifth condition are satisfied, the fifth condition being a condition that the prospective sight-line predicted at the first time point is directed toward a predetermined specific area; execute the second control when the second condition, the fourth condition, and a sixth condition are satisfied, the sixth condition being a condition that the current sight-line recognized based on the vehicle interior image at the second time point is directed toward the specific area; and execute the suspension control when any one of the second condition, the fourth condition, or the sixth condition is unsatisfied.

According to this aspect, the prospective action of the occupant is predicted based on the prospective posture and the prospective sight-line in addition to the prospective motion of the occupant, thereby improving the accuracy of the prediction.

Preferably, the device 3 (4, 5) is an opening and closing member (the door 3) installed in the vehicle 2, and the device controller 33 is configured to unlock the opening and closing member (the door 3) in the first control, open the opening and closing member in the second control, and lock the opening and closing member in the suspension control.

According to this aspect, the opening and closing member can be controlled based on the motion of the occupant. Since the vehicle controller 1 locks the opening and closing member (the door 3) through the suspension control, the opening and closing member can be returned to the state prior to execution of the first control.

Preferably, the device controller 33 is configured to close the opening and closing member (the door 3) and then lock the opening and closing member (the door 3) in a case where the suspension control is executed while the opening and closing member (the door 3) is in an open state.

According to this aspect, the opening and closing member (the door 3) can be reliably locked.

Preferably, the vehicle controller 1 further includes: a vehicle exterior image acquirer 32 configured to acquire a vehicle exterior image, which is an image of an exterior of the vehicle 2; and an obstacle detector 43 configured to detect an obstacle around the opening and closing member based on the vehicle exterior image, and the device controller 33 is configured to execute the suspension control in a case where the obstacle detector 43 detects the obstacle at the second time point.

According to this aspect, it is possible to avoid contact between the opening and closing member (the door 3) and the obstacle.

Preferably, the motion predictor 37 is configured to predict the prospective motion corresponding to the specific motion based on an operation by the occupant on another device of the vehicle 2 different from the opening and closing member.

According to this aspect, the accuracy of the prediction of the prospective motion is improved.

Preferably, the device 3 (4, 5) is a lighting device 4 installed in the vehicle 2, and the device controller 33 is configured to turn on the lighting device 4 in the first control, keep the lighting device 4 on in the second control, and turn off the lighting device 4 in the suspension control.

According to this aspect, it is possible to control the lighting device 4 based on the motion of the occupant.

Preferably, the device 3 (4, 5) is a display device 5 installed in the vehicle 2, and the device controller 33 is configured to turn on the display device 5 in the first control, keep the display device 5 on in the second control, and turn off the display device 5 in the suspension control.

According to this aspect, it is possible to control the display device 5 based on the motion of the occupant.

According to another aspect, a vehicle control method includes: acquiring, by a computer, a vehicle interior image, which is an image of an interior of a vehicle cabin 8 of a vehicle 2; recognizing, by the computer, a current motion of an occupant based on the vehicle interior image; predicting, by the computer, a prospective motion of the occupant based on the vehicle interior image; executing, by the computer, a first control of a device 3 (4, 5) of the vehicle 2 based on the prospective motion when a first condition is satisfied, the first condition being a condition that the prospective motion predicted at a first time point corresponds to a predetermined specific motion; executing, by the computer, a second control of the device 3 (4, 5) when a second condition is satisfied, the second condition being a condition that the current motion recognized based on the vehicle interior image at a second time point, which comes after a prescribed time elapses from the first time point, corresponds to the specific motion; and executing, by the computer, a suspension control that suspends control of the device 3 (4, 5) when the second condition is unsatisfied.

According to this aspect, it is possible to provide a vehicle control method that enables control of the device 3 (4, 5) according to the intention of the occupant.

According to another aspect, a non-transitory computer-readable storage medium including a control program, wherein the control program, when executed by a computer, executes a vehicle control method, includes: acquiring, by a computer, a vehicle interior image, which is an image of an interior of a vehicle cabin 8 of a vehicle 2; recognizing, by the computer, a current motion of an occupant based on the vehicle interior image; predicting, by the computer, a prospective motion of the occupant based on the vehicle interior image; executing, by the computer, a first control of a device 3 (4, 5) of the vehicle 2 based on the prospective motion when a first condition is satisfied, the first condition being a condition that the prospective motion predicted at a first time point corresponds to a predetermined specific motion; executing, by the computer, a second control of the device 3 (4, 5) when a second condition is satisfied, the second condition being a condition that the current motion recognized based on the vehicle interior image at a second time point, which comes after a prescribed time elapses from the first time point, corresponds to the specific motion; and executing, by the computer, a suspension control that suspends control of the device 3 (4, 5) when the second condition is unsatisfied.

According to this aspect, it is possible to provide a storage medium that enables control of the device 3 (4, 5) according to the intention of the occupant.

1. A vehicle controller comprising:
a vehicle interior image acquirer configured to acquire a vehicle interior image, which is an image of an interior of a vehicle cabin of a vehicle;
a motion recognizer configured to recognize a current motion of an occupant based on the vehicle interior image;
a motion predictor configured to predict a prospective motion of the occupant based on the current motion; and
a device controller configured to control a device installed in the vehicle, wherein
the device controller is configured to:
execute a first control of the device based on the prospective motion when a first condition is satisfied, the first condition being a condition that the prospective motion predicted at a first time point corresponds to a predetermined specific motion;
execute a second control of the device when a second condition is satisfied, the second condition being a condition that the current motion recognized based on the vehicle interior image at a second time point, which comes after a prescribed time elapses from the first time point, corresponds to the specific motion; and
execute a suspension control that suspends control of the device when the second condition is unsatisfied.

2. The vehicle controller according to claim 1, further comprising:
a posture recognizer configured to recognize a current posture of the occupant based on the vehicle interior image; and
a posture predictor configured to predict a prospective posture of the occupant based on the current posture, wherein
the device controller is configured to:
execute the first control when the first condition and a third condition are satisfied, the third condition being a condition that the prospective motion predicted at the first time point corresponds to a predetermined specific posture;
execute the second control when the second condition and a fourth condition are satisfied, the fourth condition being a condition that the current posture recognized based on the vehicle interior image at the second time point corresponds to the specific posture; and
execute the suspension control when either the second condition or the fourth condition is unsatisfied.

3. The vehicle controller according to claim 2, wherein the motion predictor is configured to predict the prospective motion based on the current motion recognized by the motion recognizer and the prospective posture predicted by the posture predictor.

4. The vehicle controller according to claim 1, further comprising:
a sight-line recognizer configured to recognize a current sight-line of the occupant based on the vehicle interior image; and
a sight-line predictor configured to predict a prospective sight-line of the occupant based on the current sight-line, wherein
the device controller is configured to:
execute the first control when the first condition and a fifth condition are satisfied, the fifth condition being a condition that the prospective sight-line predicted at the first time point is directed toward a predetermined specific area;
execute the second control when the second condition and a sixth condition are satisfied, the sixth condition being a condition that the current sight-line recognized based on the vehicle interior image at the second time point is directed toward the specific area; and
execute the suspension control when either the second condition or the sixth condition is unsatisfied.

5. The vehicle controller according to claim 2, further comprising:
a sight-line recognizer configured to recognize a current sight-line of the occupant based on the vehicle interior image; and
a sight-line predictor configured to predict a prospective sight-line of the occupant based on the vehicle interior image, wherein
the device controller is configured to:
execute the first control when the first condition, the third condition, and a fifth condition are satisfied, the fifth condition being a condition that the prospective sight-line predicted at the first time point is directed toward a predetermined specific area;
execute the second control when the second condition, the fourth condition, and a sixth condition are satisfied, the sixth condition being a condition that the current sight-line recognized based on the vehicle interior image at the second time point is directed toward the specific area; and
execute the suspension control when any one of the second condition, the fourth condition, or the sixth condition is unsatisfied.

6. The vehicle controller according to claim 1, wherein the device is an opening and closing member installed in the vehicle,
the device controller is configured to unlock the opening and closing member in the first control, open the opening and closing member in the second control, and lock the opening and closing member in the suspension control.

7. The vehicle controller according to claim 6, wherein the device controller is configured to close the opening and closing member and then lock the opening and closing member in a case where the suspension control is executed while the opening and closing member is in an open state.

8. The vehicle controller according to claim 6, further comprising:
a vehicle exterior image acquirer configured to acquire a vehicle exterior image, which is an image of an exterior of the vehicle; and
an obstacle detector configured to detect an obstacle around the opening and closing member based on the vehicle exterior image, wherein
the device controller is configured to execute the suspension control in a case where the obstacle detector detects the obstacle at the second time point.

9. The vehicle controller according to claim 6, wherein the motion predictor is configured to predict the prospective motion corresponding to the specific motion based on an operation by the occupant on another device of the vehicle different from the opening and closing member.

10. The vehicle controller according to claim 1, wherein the device is a lighting device installed in the vehicle, and the device controller is configured to turn on the lighting device in the first control, keep the lighting device on in the second control, and turn off the lighting device in the suspension control.

11. The vehicle controller according to claim 1, wherein the device is a display device installed in the vehicle, and the device controller is configured to turn on the display device in the first control, keep the display device on in the second control, and turn off the display device in the suspension control.

12. A vehicle control method comprising:
acquiring, by a computer, a vehicle interior image, which is an image of an interior of a vehicle cabin of a vehicle;
recognizing, by the computer, a current motion of an occupant based on the vehicle interior image;
predicting, by the computer, a prospective motion of the occupant based on the vehicle interior image;
executing, by the computer, a first control of a device of the vehicle based on the prospective motion when a first condition is satisfied, the first condition being a condition that the prospective motion predicted at a first time point corresponds to a predetermined specific motion;
executing, by the computer, a second control of the device when a second condition is satisfied, the second condition being a condition that the current motion recognized based on the vehicle interior image at a second time point, which comes after a prescribed time elapses from the first time point, corresponds to the specific motion; and
executing, by the computer, a suspension control that suspends control of the device when the second condition is unsatisfied.

13. A non-transitory computer-readable storage medium comprising a control program, wherein the control program, when executed by a computer, executes a vehicle control method, comprising:
acquiring, by a computer, a vehicle interior image, which is an image of an interior of a vehicle cabin of a vehicle;
recognizing, by the computer, a current motion of an occupant based on the vehicle interior image;
predicting, by the computer, a prospective motion of the occupant based on the vehicle interior image;
executing, by the computer, a first control of a device of the vehicle based on the prospective motion when a first condition is satisfied, the first condition being a condition that the prospective motion predicted at a first time point corresponds to a predetermined specific motion;
executing, by the computer, a second control of the device when a second condition is satisfied, the second condition being a condition that the current motion recognized based on the vehicle interior image at a second time point, which comes after a prescribed time elapses from the first time point, corresponds to the specific motion; and
executing, by the computer, a suspension control that suspends control of the device when the second condition is unsatisfied.
